(19) United States
(12) Patent Application Publication
(10) Pub. No.: US 2016/0355046 A1
(43) Pub. Date: Dec. 8, 2016

(54) DISK-BOUND SCRAPBOOK SYSTEM

(71) Applicant: Continental Accessory Corporation, Amityville, NY (US)

(72) Inventor: Ronald Koeppel, Brookville, NY (US)

(21) Appl. No.: 15/164,112

(22) Filed: May 25, 2016

Related U.S. Application Data
(60) Provisional application No. 62/170,884, filed on Jun. 4, 2015.

(51) Int. Cl. B42F 5/00; B42F 3/00

(52) U.S. Cl. CPC B42F 5/00; B42F 3/003

(57) ABSTRACT

A scrapbook system is disclosed. The scrapbook system includes a pair of covers a spine permanently connecting the pair of covers, a stack of plural of pages and a plurality of disks. Each of the disks is circular and has a generally planar central section and an enlarged peripheral rim. The disks are located in respective slots in the spine. Each of the pages has an inner edge and a plurality of slots spaced along the inner edge for receipt of respective ones of the disks to releasably mount the pages to the spine and the covers. At least some of the pages include at least one pocket for receipt of a keepsake item, with portions of at least some of the pages being transparent to enable one to view a keepsake item located in the pocket through the transparent portion of the page.

### CROSS-REFERENCE TO RELATED APPLICATIONS

This non-provisional application claims the benefit under 35 U.S.C. §119(e) of Provisional Application Ser. No. 62/170,884 filed on Jun. 4, 2015, entitled Disk-Bound Scrapbook System, the entire disclosure of that provisional application is hereby incorporated by reference herein.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISK

Not Applicable

### FIELD OF THE INVENTION

This invention relates generally to scrapbook systems with removable pages and more particularly to scrapbook systems whose removable pages are held within a cover having a permanent spine via plural disks mounted in the spine.

### BACKGROUND OF THE INVENTION

Notebook systems making use of a stack of sheets is bound together using a plurality of disks are commercially available from various sources, including Continental Accessory, Corp., the assignee of the subject invention. Those notebook systems include a separate front cover, a separate rear cover, a plurality of disks and a stack of sheets, e.g., paper sheets. Each of the sheets and the covers include a plurality of mushroom-like shaped slots along one marginal edge thereof. Each of the slots is arranged to receive a respective disk to bind all of the sheets and covers together, so that the notebook serves as a binder with removable sheets. Some of the foregoing systems can be configured for usage as scrapbooks. To that end, such systems make use of pages which have at least one pocket therein for accepting and holding a keepsake item, a photograph, a card, a letter, stamps, etc.

U.S. Pat. No. 5,553,959 (Feldman et al.) and 5,749,667 (Feldman et al.) disclose notebook systems like the foregoing. In particular, the Feldman et al. systems make use of a stack of sheets is bound together between a front and rear cover using a plurality of disks that are inserted into mushroom shaped slots in the edge of each of the sheets of the stack and each of the covers. Each of the plural disks has a substantially flat disk-like central surface portion and an enlarged continuous rim portion which extends around the periphery of the central surface portion. The rim portion extends outwardly in a direction perpendicular to the flat central portions of the disks, and the central surface portion has a radius which is larger than the thickness of a stack of sheets to be bound thereby.

While such prior art notebook or scrapbook systems are generally suitable for their intended purposes, the fact that the disks serves to secure the cover panels together, leaves them susceptible to accidental disconnection. Moreover, such systems leave something to be desired from the standpoint of aesthetics due to the manner in which the cover panels are connected together by the disks. Thus, a need exists for a disk bound scrapbook system which is resistant to accidental disconnection of the disks from the cover panels and which is aesthetically pleasing in appearance. The subject invention addresses those needs.

All references cited and/or identified herein are specifically incorporated by reference herein.

### SUMMARY OF THE INVENTION

In accordance with one aspect of this invention a scrapbook system is provided. The scrap book system comprises a cover assembly, a plurality of disks, and a plurality of pages. Each of the disks is circular and has a generally planar central section having a predetermined thickness and an enlarged peripheral rim extending about the central section. The cover assembly comprises a pair of cover panels and a spine. The spine comprises a generally U-shaped member having a central section and a pair of edge sections. The central section is of a predetermined width and includes a plurality of spaced-apart slots. The edge sections are located on opposite sides of the central section and each is fixedly secured to a respective edge portion of a respective one of the cover panels. Each of the slots of the spine comprises a generally linear section and a pair of bulbous end sections located on respective ends of the linear section, with the disks being located in respective ones of the slots of the spine. Each page comprises a web of material having an inner edge and a plurality of slots spaced along the inner edge. Each of the slots of each page comprises an entryway channel extending inward from the inner edge and terminating at an enlarged opening for receipt of the enlarged peripheral rim and contiguous planar central section of a respective one of the plurality of disks.

In accordance with another aspect of this invention each page of the scrapbook system comprises at least one pocket therein for receipt of a keepsake item.

### DESCRIPTION OF THE DRAWING

FIG. 1 is an isometric view of one exemplary embodiment of a scrapbook system constructed in accordance with this invention;

FIG. 2 is an isometric view showing the exemplary embodiment of the scrapbook system of FIG. 1, but with the front cover opened (e.g., folded back) to expose the stack of pages of the scrapbook system;

FIG. 3 is a plan view of one exemplary embodiment of a page of the disk-bound scrapbook system shown in FIGS. 1 and 2;

FIG. 4 is an enlarged plan view of the portion of the page shown within the broken circle designed by the reference number 4 in FIG. 3;

FIG. 5 is an enlarged sectional view taken along line 5-5 of FIG. 3;

FIG. 6 is an enlarged front elevation view of a portion of the spine of the scrapbook system shown in FIGS. 1 and 2.

### DETAILED DESCRIPTION OF THE PREFERRED EMBODIMENT

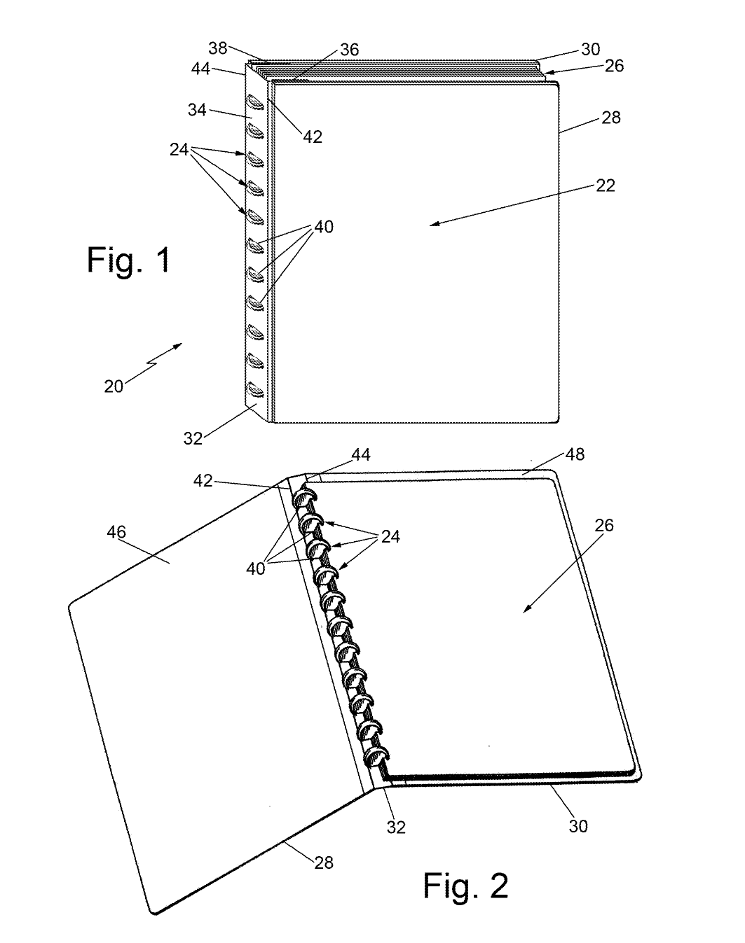

Referring now to the various figures of the drawing wherein like reference characters refer to like parts, there is shown at 20 in FIG. 1 one exemplary embodiment of a scrapbook system 20 constructed in accordance with this invention.

The scrapbook basically comprises a cover assembly 22, a plurality of disks 24 and a plurality of pages 26. The cover assembly includes a front or top cover member or panel 28, a bottom or rear cover member or panel 30, and a spine 32. The cover members are each generally planar members formed of any suitable material, e.g., cardboard, leather, polypropylene, polyvinyl chloride, polyurethane, etc. The spine 32 is a generally U-shaped member formed of any suitable material, e.g., cardboard, leather, polypropylene, polyvinyl chloride, polyurethane, etc. The spine 32 is a generally U-shaped member formed of any suitable material, and has a central section 34 and a pair of edge sections 36 and 38. The central section is of a predetermined width and includes a plurality of equidistantly spaced-apart slots 40 extending along the length of the spine.

The edge sections 36 and 38 are located on opposite sides of the central section 34 by respective hinge lines 42 and 44 to enable each edge section to pivot with respect to the central section 34 along its respective hinge line. The edge section 36 is fixedly secured to the inner surface of the front cover panel 28 by any suitable means, e.g., an adhesive (not shown). In a similar manner, the edge section 38 is fixedly secured to the inner surface of the rear cover panel 30 by any suitable means, e.g., an adhesive (not shown). Thus the spine fixedly secures the front and rear cover panels together, while enabling them to be pivoted about their respective hinge lines to enable the cover panels to be closed, like shown in FIG. 1, or opened, like shown in FIG. 2.

In the interest of aesthetics, a liner sheet 46 is adhesively secured on the inner surface of the front cover panel 28 with the edge section 36 of the spine interposed therebetween to hide it as can be seen in FIG. 2. In a similar manner, a liner sheet 48 is adhesively secured on the inner surface of the rear cover panel 30 with the edge section 38 of the spine interposed therebetween to hide it.

Turning now to FIG. 6, the details of the slots 40 in the spine will now be described. Thus, as can be seen each slot 40 basically comprises a linear central channel 40A which extends perpendicularly to the longitudinal axis of the spine, i.e., the channel extends transversely. The channel 40 includes an opposed pair of ends, each of which is in the form of an enlarged opening 40B. Each opening is somewhat mushroom-like in shape, with the outer edge 40C of the enlarged opening 40B being linear.

As mentioned above each of the disks 24 is arranged to be received in a respective slot 40. Thus, the disks 24 are circular and are of a cross-section which is shaped to mate with the slots 40. In particular, the periphery of each disk comprises an enlarged continuous rim portion extending around the entire periphery of the disk member, with the rim portion having shape corresponding to the shape of the openings 40B of the slot 40. The central section of each disk is planar and is of a thickness slightly less than the width of the channel 40A so that it can be received within the channel, when portions of the rim of the disk are within the enlarged openings 40B.

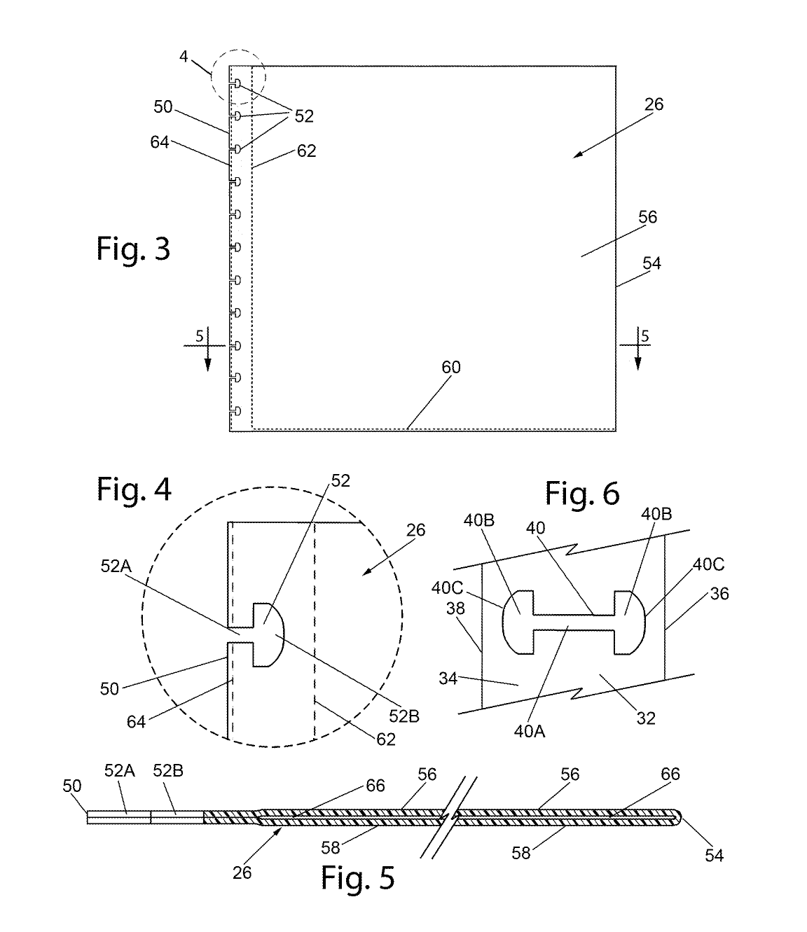

As mentioned earlier the disks 24 serve to releasably mount the pages 26 to the spine and between the cover panels. To that end, as best seen in FIGS. 3 and 4, each page 26 is includes a marginal edge portion 50 having a plurality of generally mushroom-like shaped slots 52 equidistantly located therealong to receive a respective one of the plurality of disks 24 therein. The slots 52 are best seen in FIG. 4 and basically each comprises one half of the slot 40 described earlier. To that end, each slot 52 includes an entryway or channel 52A which extends inward from the edge 50 of the page 26 and is perpendicular to that edge. Each channel 52A terminates at an enlarged opening 52B which is identical to the opening 40B. Thus a portion of the rim of the disk 24 can be located within the enlarged opening 52B, while the contiguous central portion of the disk is located within the channel 52A.

In accordance with a preferred embodiment of this invention at least some of the pages of the stack of pages of the system is constructed to include a pocket for holding a keepsake item. In the exemplary embodiment shown all of the pages 24 are so constructed. Moreover, the pages are preferably transparent (or at least include transparent portions contiguous with the pocket) to enable the keepsake item within the pocket to be readily viewed through the transparent portion of the page. Thus as can be seen in FIGS. 3 and 5 each page basically comprises a sheet or web of a transparent plastic material which is folded into half along an outer marginal edge 54 to form a top sheet 56 and a bottom sheet 58. The lower edge of the top sheet and bottom sheet are secured, e.g., welded, together along a bottom seal line 60. A portion of the top and bottom sheet closely adjacent the slots 52 are secured, e.g., welded, together along an intermediate seal line 62. The portions of the top sheet and the bottom sheet immediately adjacent the edge 50 are also secured, e.g., welded, together along an edge seal line 64. This arrangement forms a hollow pocket 66 between the top sheet and the bottom sheet. The top edges of the top sheet and the bottom sheet are not secured together to provide an entryway or mouth for the pocket 66, through which a keepsake item can be introduced into the pocket.

By virtue of the fact that the page 24 is of double thickness and secured together by the seal lines 62 and 64, the inner edge of the page in which the slots 54 are located is reinforced. This ensures that the sheet is resistant to damage when it is inserted into the scrapbook or removed from the scrapbook.

As mentioned earlier, the page is preferably formed of a plastic material that is transparent. However, it could be opaque and/or colored in the interest of aesthetics.

Without further elaboration the foregoing will so fully illustrate my invention that others may, by applying current or future knowledge, adopt the same for use under various conditions of service.

I claim:

1. A scrapbook system comprising a cover assembly, a plurality of disks, and a plurality of pages, each of said disks is circular and has a generally planar central section having a predetermined thickness and an enlarged peripheral rim extending about said central section, said cover assembly comprises a pair of cover panels and a spine, said spine comprises a generally U-shaped member having a central section and a pair of edge sections, said central section being of a predetermined width and including a plurality of spaced-apart slots, said edge sections being located on opposite sides of said central section and each being fixedly secured to a respective edge portion of a respective one of said cover panels, each of said slots of said spine comprising a generally linear section and a pair of bulbous end sections located on respective ends of said linear section, with said disks being located in respective ones of said slots of said spine, each of said pages comprises a web of material having an inner edge and a plurality of slots spaced along said inner edge, each of said slots of each of said pages comprising an entryway channel extending inward from said inner edge and terminating at an enlarged opening for receipt of said enlarged peripheral rim and contiguous planar central section of a respective one of said plurality of disks.

2. The scrapbook system of claim 1 wherein said slots in said spine are equidistantly spaced from each other.

3. The scrapbook system of claim 1 wherein at least some of said pages of said scrapbook system comprise at least one pocket therein for receipt of a keepsake item.

4. The scrapbook system of claim 3 wherein at least some of said pages of said scrapbook system include at least one transparent portion located at said at least one pocket to enable the keepsake item located within said pocket to be viewed while in said pocket.

5. The scrapbook system of claim 2 wherein at least some of said pages of said scrapbook system comprise at least one pocket therein for receipt of a keepsake item.

6. The scrapbook system of claim 5 wherein at least some of said pages of said scrapbook system include at least one transparent portion located at said at least one pocket to enable the keepsake item located within said pocket to be viewed while in said pocket.

7. The scrapbook system of claim 1 wherein each of said edge sections of said spine is connected to said central section of said spine by a hinge line to enable said edge sections to pivot with respect to said central section.

8. The scrapbook system of claim 2 wherein each of said edge sections of said spine is connected to said central section of said spine by a hinge line to enable said edge sections to pivot with respect to said central section.

9. The scrapbook system of claim 3 wherein each of said edge sections of said spine is connected to said central section of said spine by a hinge line to enable said edge sections to pivot with respect to said central section.

10. The scrapbook system of claim 4 wherein each of said edge sections of said spine is connected to said central section of said spine by a hinge line to enable said edge sections to pivot with respect to said central section.

11. The scrapbook system of claim 1 additionally comprising a pair of liner sheets, one of said liner sheets being secured to one of said pair of cover panels, with a one of said edge sections of said spine interposed between said one of said pair of cover panels and said one of said pair of liner sheets, and with the other of said pair of liner sheets being secured to the other of said pair of cover panels, with the other of said edge sections of said spine interposed between said other of said pair of cover panels and said other of said pair of liner sheets.

12. The scrapbook system of claim 2 additionally comprising a pair of liner sheets, one of said liner sheets being secured to one of said pair of cover panels, with a one of said edge sections of said spine interposed between said one of said pair of cover panels and said one of said pair of liner sheets, and with the other of said pair of liner sheets being secured to the other of said pair of cover panels, with the other of said edge sections of said spine interposed between said other of said pair of cover panels and said other of said pair of liner sheets.

13. The scrapbook system of claim 3 additionally comprising a pair of liner sheets, one of said liner sheets being secured to one of said pair of cover panels, with a one of said edge sections of said spine interposed between said one of said pair of cover panels and said one of said pair of liner sheets, and with the other of said pair of liner sheets being secured to the other of said pair of cover panels, with the other of said edge sections of said spine interposed between said other of said pair of cover panels and said other of said pair of liner sheets.

14. The scrapbook system of claim 4 additionally comprising a pair of liner sheets, one of said liner sheets being secured to one of said pair of cover panels, with a one of said edge sections of said spine interposed between said one of said pair of cover panels and said one of said pair of liner sheets, and with the other of said pair of liner sheets being secured to the other of said pair of cover panels, with the other of said edge sections of said spine interposed between said other of said pair of cover panels and said other of said pair of liner sheets.

15. The scrapbook system of claim 7 additionally comprising a pair of liner sheets, one of said liner sheets being secured to one of said pair of cover panels, with a one of said edge sections of said spine interposed between said one of said pair of cover panels and said one of said pair of liner sheets, and with the other of said pair of liner sheets being secured to the other of said pair of cover panels, with the other of said edge sections of said spine interposed between said other of said pair of cover panels and said other of said pair of liner sheets.
